(19) United States
(12) Patent Application Publication
(10) Pub. No.: US 2019/0251675 A1
(43) Pub. Date: Aug. 15, 2019

(54) IMAGE PROCESSING METHOD, IMAGE PROCESSING DEVICE AND STORAGE MEDIUM

(71) Applicant: MEGVII TECHNOLOGY LLC, Redmond, WA (US)

(72) Inventors: Xue BAI, Redmond, WA (US); Jue WANG, Redmond, WA (US)

(21) Appl. No.: 15/892,836

(22) Filed: Feb. 9, 2018

(51) Int. Cl. G06T 5/00; G06T 5/20; G06T 5/50

(52) U.S. Cl. CPC G06T 5/006; G06T 5/20; G06T 2207/20221; G06T 2207/30201; G06T 5/50

(57) ABSTRACT

An image processing method, an image processing device and a computer-readable storage medium. The image processing method includes: performing face detection on an input image to obtain original key points; performing distortion processing on the input image to obtain correction key points corresponding to the original key points of the input image; and performing deformation processing on the input image according to the correction key points and the original key points to obtain an output image.

### TECHNICAL FIELD

Embodiments of the present disclosure relate to an image processing method, an image processing device and a computer-readable storage medium.

### BACKGROUND

Lens distortion is an inherent perspective distortion of an optical lens. The lens distortion mainly comprises pincushion distortion, barrel distortion, linear distortion, and so on.

A wide-angle lens is a photographic lens with a shorter focal length than a standard lens and a larger viewing angle than the standard lens. The wide-angle lens has the characteristics, such as a large lens viewing angle, wide field of vision, etc. Thus, wide-angle lenses are widely used in photography, security, mobile phones and other imaging systems. Due to the large viewing angle of the wide-angle lens, it is easy to cause deformation of objects during the process of imaging, and so, a distortion phenomenon may occur. The closer an object is to an edge of a picture, the larger the distortion is, and the distortion of a human face at the edge of the picture is especially noticeable.

### SUMMARY

The present disclosure has been proposed in view of the above problems. The present disclosure provides an image processing method, an image processing device and a computer-readable storage medium.

At least an embodiment of the present disclosure provides an image processing method, which comprises: performing face detection on an input image to obtain original key points; performing distortion processing on the input image to obtain correction key points corresponding to the original key points of the input image; and performing deformation processing on the input image according to the correction key points and the original key points to obtain an output image.

For example, in the image processing method provided by an embodiment of the present disclosure, the performing distortion processing on the input image to obtain correction key points corresponding to the original key points of the input image comprises: converting the original key points of the input image into intermediate key points by using a barrel distortion formula; and aligning a barycenter of the intermediate key points with a barycenter of the original key points to obtain the correction key points.

For example, in the image processing method provided by an embodiment of the present disclosure, the aligning a barycenter of the intermediate key points with a barycenter of the original key points to obtain the correction key points comprises: calculating the barycenter of the original key points; calculating the barycenter of the intermediate key points; calculating a barycentric vector of the original key points according to the barycenter of the original key points and the barycenter of the intermediate key points; and aligning the barycenter of the intermediate key points with the barycenter of the original key points according to the barycentric vector of the original key points, so as to obtain the correction key points.

For example, in the image processing method provided by an embodiment of the present disclosure, the performing deformation processing on the input image according to the correction key points and the original key points to obtain the output image comprises: performing mesh processing on the input image to obtain an original mesh image; performing the deformation processing on the original mesh image according to the original key points and the correction key points to obtain a correction mesh image; and performing pixel-value padding processing on the correction mesh image according to the input image to obtain the output image.

For example, in the image processing method provided by an embodiment of the present disclosure, the performing the deformation processing on the original mesh image according to the original key points and the correction key points to obtain the correction mesh image comprises: performing first interpolation processing according to the original key points and the correction key points to obtain respective moving vectors of a plurality of intersection points of the original mesh image; and obtaining the correction mesh image according to respective positions and the respective moving vectors of the plurality of intersection points of the original mesh image.

For example, in the image processing method provided by an embodiment of the present disclosure, the first interpolation processing comprises thin plate spline interpolation processing. The performing first interpolation processing according to the original key points and the correction key points to obtain respective moving vectors of the plurality of intersection points of the original mesh image comprises: obtaining moving vectors of the original key points according to the original key points and the correction key points; calculating parameters of a interpolation formula of the thin plate spline interpolation according to the moving vectors of the original key points; and calculating the respective moving vectors of the plurality of intersection points of the original mesh image according to the parameters and the interpolation formula, each of the moving vectors comprising a first moving component and a second moving component.

For example, in the image processing method provided by an embodiment of the present disclosure, the performing pixel-value padding processing on the correction mesh image according to the input image to obtain the output image comprises: performing fusion processing on a non-face area of the original mesh image and a face area of the correction mesh image to obtain an output mesh image; and determining a pixel value of each pixel in the output mesh image according to the input image, so as to obtain the output image.

For example, in the image processing method provided by an embodiment of the present disclosure, the performing fusion processing on the non-face area of the original mesh image and the face area of the correction mesh image comprises: obtaining a face mask of the input image according to the original key points; performing blurring processing on the face mask to obtain a blurred face mask; obtaining a blurred non-face mask according to the blurred face mask; obtaining the non-face area of the original mesh image according to the blurred face mask and the original mesh image; obtaining the face area of the correction mesh image according to the blurred non-face mask and the correction mesh image; and fusing the non-face area of the original mesh image and the face area of the correction mesh image to obtain the output mesh image.

For example, in the image processing method provided by an embodiment of the present disclosure, the output mesh image is expressed as: W_{O}=W_{I}·Mₐ+W_{co}·M_{b}. W_{O} denotes the output mesh image, W_{I} denotes the original mesh image, W_{co} denotes the correction mesh image, Mₐ denotes the blurred face mask, and M_{b} denotes the blurred non-face mask, M_{b}M₁−Mₐ, M₁ denotes an all 1 matrix.

For example, in the image processing method provided by an embodiment of the present disclosure, the blurring processing comprises Gaussian blur.

For example, in the image processing method provided by an embodiment of the present disclosure, the determining the pixel value of each pixel in the output mesh image according to the input image to obtain the output image comprises: performing mesh triangulation processing on the output mesh image to obtain an intermediate mesh image; performing second interpolation processing according to the input image to determine the pixel value of each pixel in the intermediate mesh image, so as to obtain an intermediate output image; and performing cropping processing on the intermediate output image to obtain the output image.

For example, in the image processing method provided by an embodiment of the present disclosure, the second interpolation processing comprises bilinear interpolation.

For example, in the image processing method provided by an embodiment of the present disclosure, the input image comprises a plurality of faces. The performing face detection on the input image to obtain original key points comprises: performing the face detection on the input image to obtain original key points of each face of the plurality of faces.

For example, in the image processing method provided by an embodiment of the present disclosure, the performing distortion processing on the input image to obtain correction key points corresponding to the original key points of the input image comprises: converting the original key points of each face into intermediate key points of each face by using a barrel distortion formula; and aligning a barycenter of the intermediate key points of each face with a barycenter of the original key points of each face to obtain the correction key points of each face.

For example, in the image processing method provided by an embodiment of the present disclosure, the performing deformation processing on the input image according to the correction key points and the original key points to obtain the output image comprises: performing mesh processing on the input image to obtain an original mesh image; performing the deformation processing on the original mesh image according to original key points and correction key points of the plurality of faces to obtain a correction mesh image; and performing pixel-value padding processing on the correction mesh image according to the input image to obtain the output image.

At least an embodiment of the present disclosure further provides an image processing device, which comprises: a storage, used for storing non-transitory computer-readable instructions; and a processor, used for executing the non-transitory computer-readable instructions, the non-transitory computer-readable instructions, as executed by the processor, cause the processor to perform steps including: performing face detection on an input image to obtain original key points; performing distortion processing on the input image to obtain correction key points corresponding to the original key points of the input image; and performing deformation processing on the input image according to the correction key points and the original key points to obtain an output image.

For example, in the image processing device provided by an embodiment of the present disclosure, the step of performing distortion processing on the input image to obtain correction key points corresponding to the original key points of the input image comprises: converting the original key points of the input image into intermediate key points by using a barrel distortion formula; and aligning a barycenter of the intermediate key points with a barycenter of the original key points to obtain the correction key points.

For example, in the image processing device provided by an embodiment of the present disclosure, the step of performing deformation processing on the input image according to the correction key points and the original key points to obtain the output image comprises: performing mesh processing on the input image to obtain an original mesh image; performing the deformation processing on the original mesh image according to the original key points and the correction key points to obtain a correction mesh image; and performing pixel-value padding processing on the correction mesh image according to the input image to obtain the output image.

At least an embodiment of the present disclosure further provides a computer-readable storage medium which is used for storing non-transitory computer-readable instructions. The non-transitory computer-readable instructions as executed by a computer cause the computer to perform steps including: performing face detection on an input image to obtain original key points; performing distortion processing on the input image to obtain correction key points corresponding to the original key points of the input image; and performing deformation processing on the input image according to the correction key points and the original key points to obtain an output image.

For example, in the computer-readable storage medium provided by an embodiment of the present disclosure, the step of performing distortion processing on the input image to obtain correction key points corresponding to the original key points of the input image comprises: converting the original key points of the input image into intermediate key points by using a barrel distortion formula; and aligning a barycenter of the intermediate key points with a barycenter of the original key points to obtain the correction key points.

For example, in the computer-readable storage medium provided by an embodiment of the present disclosure, performing the step of performing deformation processing on the input image according to the correction key points and the original key points to obtain the output image comprises: performing mesh processing on the input image to obtain an original mesh image; performing the deformation processing on the original mesh image according to the original key points and the correction key points to obtain a correction mesh image; and performing pixel-value padding processing on the correction mesh image according to the input image to obtain the output image.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative to the disclosure.

FIG. 1A is a schematic flowchart of an image processing method provided by an embodiment of the present disclosure;

FIG. 1B is a specific flowchart of an image processing method provided by an embodiment of the present disclosure;

FIG. 2 is a schematic diagram of intermediate key points in an input image provided by an embodiment of the present disclosure;

FIG. 3 is a schematic diagram of correction key points in an input image provided by an embodiment of the present disclosure;

FIG. 4 is a schematic diagram of performing interpolation processing on an original mesh image by using thin plate spline interpolation according to an embodiment of the present disclosure;

FIG. 5A is a schematic diagram of a correction mesh image provided by an embodiment of the present disclosure;

FIG. 5B is a schematic diagram of a correction image corresponding to a correction mesh image provided by an embodiment of the present disclosure;

FIG. 6 is a schematic diagram of an intermediate output image provided by an embodiment of the present disclosure;

FIG. 7 is a schematic diagram of an output image provided by an embodiment of the present disclosure;

FIG. 8A is a schematic diagram of a face area before distortion correction according to an embodiment of the present disclosure;

FIG. 8B is a schematic diagram of a face area obtained by processing the face area shown in FIG. 8A using an image processing method provided by an embodiment of the present disclosure;

FIG. 9A is a schematic diagram of an input image before distortion correction according to an embodiment of the present disclosure;

FIG. 9B is a schematic diagram of an output image obtained by processing the input image shown in FIG. 9A using an image processing method provided by an embodiment of the present disclosure;

FIG. 10 is a schematic block diagram of an image processing device provided by an embodiment of the present disclosure;

FIG. 11 is a schematic block diagram of another image processing device provided by an embodiment of the present disclosure; and

FIG. 12 is a schematic diagram of a computer-readable storage medium provided by an embodiment of the present disclosure.

### DETAILED DESCRIPTION

In order to make objectives, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “include,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

Image distortion refers to deformation, such as extrusion, stretching, offset and distortion, etc., of a geometric position of an image pixel relative to a reference system (an actual ground position or a topographic map) generated in the process of imaging, which causes the geometric position, size, shape, orientation, etc. of the image to be changed. The image distortion comprises lens distortion, the lens distortion is perspective distortion of the image caused by inherent characteristics of the lens (for example, a convex lens converges light and a concave lens diverges the light), and this perspective distortion is detrimental to the imaging quality of the image. Currently, for high quality lenses, different degrees of deformation and distortion may occur at edges of the lenses.

At least an embodiment of the present disclosure provides an image processing method, an image processing device and a computer-readable storage medium, which can restore a face shape of a person or face shapes of multiple persons by superimposing a barrel distortion on an image, so as to effectively remove the distortion and deformation of the human face(s) at the edges of the image caused by a camera lens.

Several embodiments of the present disclosure are described in details below, but the present disclosure is not limited to these specific embodiments.

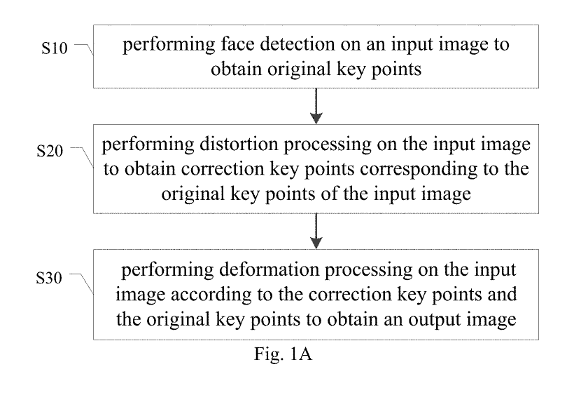

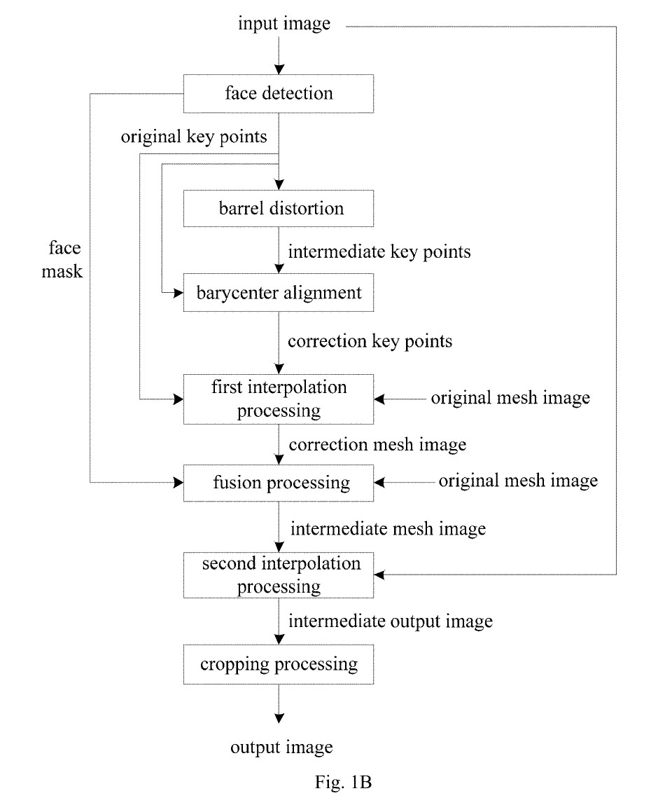

FIG. 1A is a schematic flowchart of an image processing method provided by an embodiment of the present disclosure.

For example, as shown in FIG. 1A, an image processing method provided by an embodiment of the present disclosure may comprise, but not limited to, the following steps:

Step S10: performing face detection on an input image to obtain original key points;

Step S20: performing distortion processing on the input image to obtain correction key points corresponding to the original key points of the input image; and

Step S30: performing deformation processing on the input image according to the correction key points and the original key points to obtain an output image.

For example, in the step S10, the input image may be various images including human face(s), such as character images, etc. The input image may be, for instance, a grayscale image or a color image.

For example, the input image may be acquired by an image acquisition device. The image acquisition device may comprise a wide-angle lens. The image acquisition device may be a digital camera, a camera in a smart phone, a camera in a tablet computer, a camera in a personal computer, or even a network camera. The present disclosure is not limited thereto.

For example, the input image may be an original image directly acquired by the image acquisition device, or an image obtained by preprocessing the original image. For example, before the step S10, the image processing method provided by an embodiment of the present disclosure may further comprise a step of preprocessing the input image, so as to facilitate detection of a face area on the input image. A preprocessing operation can eliminate irrelevant information or noise information from the input image, so as to better perform the face detection on the input image. For example, in a case where the input image is a photograph, the preprocessing operation may comprise performing image scaling, gamma correction, image enhancement, noise reduction or filtering, etc. on the photograph; and in a case where the input image is a video, the preprocessing operation may comprise extracting a key frame or the like of the video.

For example, in the step S10, the face detection may be achieved by using approaches, such as a template-based approach, a model-based approach or a neural network approach, etc. The template-based approach may comprise, for example, an eigen-face approach, a linear discriminant analysis approach, a singular value decomposition approach, a dynamic linking matching approach, and the like. The model-based approach may comprise, for example, a hidden Markov model approach, an active shape model approach, an active appearance model approach, and the like. The neural network approach may comprise, for example, a convolutional neural network (CNN) or the like.

For example, the face detection may further comprise extracting the original key points of the face by using algorithms, such as a scale-invariant feature transform (SIFT) feature extraction algorithm and a histogram of oriented gradient (HOG) feature extraction algorithm, etc.

For example, each face may comprise a plurality of key points. The key points of the face are some key points having a strong representation ability of the face, for example, the eye(s), the canthus, the eyebrow(s), the highest point(s) of the cheekbones, the nose, the mouth, the chin, a face contour and the like. In the embodiments of the present disclosure, the original key points of the face refer to the key points of the face in the input image, and the correction key points refer to the key points of the face obtained after correcting the original key points.

For example, the barrel distortion is a common problem of the wide-angle lenses. Currently, software of the image acquisition device performs post-processing on the acquired image, so as to try to eliminate this distortion and straighten the curve at the edge of the image; however, this processing may distort the shape of the object at the edge. In order to counteract the distortion caused by the lens on the human face, the barrel distortion may be applied to the input image (the center of the input image may bulge out, and the edge of the input image may be squeezed), so that the input image is restored to a curve surface, and the shape of the object at the edge becomes natural.

For example, the step S20 may comprise the following steps:

Step S201: converting the original key points of the input image into intermediate key points by using a barrel distortion formula; and

Step S202: aligning a barycenter of the intermediate key points with a barycenter of the original key points to obtain the correction key points.

For example, in the step S201, the barrel distortion formula is expressed as:

xᵤ=x_{d}+(x_{d}−xₑ)·(K₁·r²+K₂·r⁴+ . . . )

yᵤ=y_{d}+(y_{d}−yₑ)·(K₁·r²+K₂·r⁴+ . . . )

Herein, (xᵤ,yᵤ) denotes a coordinate of an intermediate key point, (x_{d},y_{d}) denotes a coordinate of a corresponding original key point, (x_{c},y_{c}) denotes a center coordinate of the input image, r=\sqrt{(x_{d}−x_{c})²+(y_{d}−y_{c})²} and K₁ and K₂ denote high-order distortion parameters.

FIG. 1B is a specific flowchart of an image processing method provided by an embodiment of the present disclosure. For example, as shown in FIG. 1B, the image processing method provided by an embodiment of the present disclosure comprises: firstly, performing face detection on the input image to obtain original key points of a human face and a face mask determined according to the original key points; then converting the original key points of the input image into the intermediate key points by using the barrel distortion formula; then, aligning the barycenter of the intermediate key points with the barycenter of the original key points to obtain the correction key points; then performing first interpolation processing based on the original key points and the correction key points to obtain respective moving vectors of a plurality of intersection points in an original mesh image, and converting the original mesh image into a correction mesh image according to respective positions and the respective moving vectors of the plurality of intersection points; then performing fusion processing on a non-face area of the original mesh image and a face area of the correction mesh image based on the face mask to obtain an intermediate mesh image; next, performing second interpolation processing based on the input image and the intermediate mesh image to determine a pixel value of each pixel in the intermediate mesh image, so as to obtain an intermediate output image; and finally, performing cropping processing on the intermediate output image to obtain the output image.

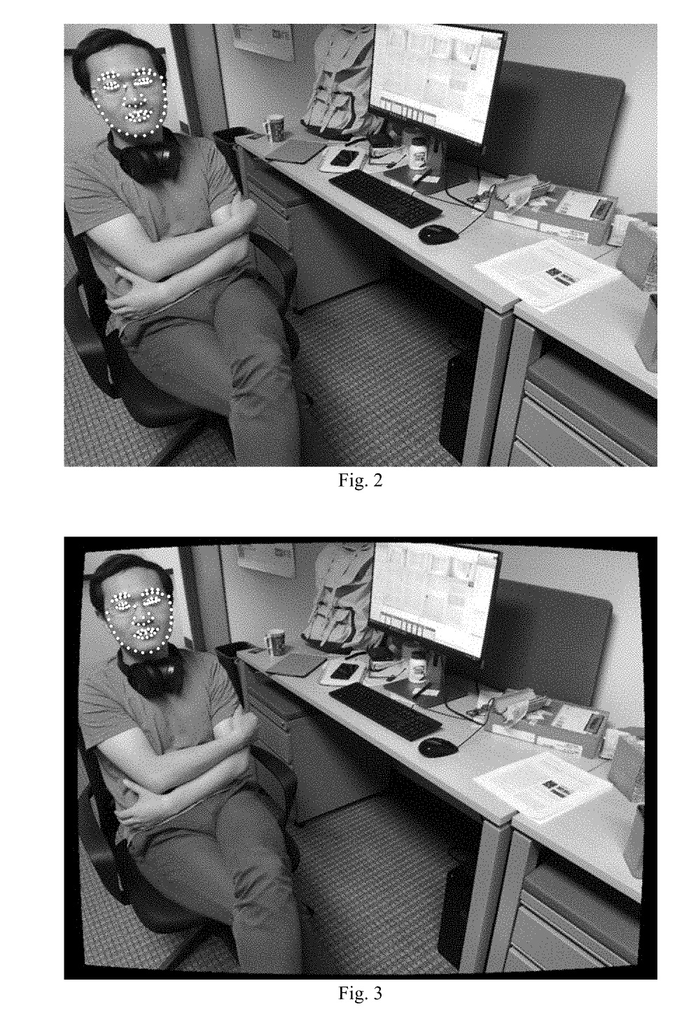

FIG. 2 is a schematic diagram of intermediate key points in an input image provided by an embodiment of the present disclosure, and FIG. 3 is a schematic diagram of correction key points in an input image provided by an embodiment of the present disclosure.

For example, the barrel distortion formula can establish a corresponding relationship between the original key points and the intermediate key points. As shown in FIG. 2, in the step S201, after the original key points of the input image are converted by using the barrel distortion formula (that is, after calculation based on the original key points by using the barrel distortion formula), the intermediate key points (the white points on the face in FIG. 2) of the face may be obtained.

Because the coordinates of the intermediate key points calculated by the barrel distortion formula may drift to the center of the image, the intermediate key points need to be translated, so that the barycenter of the intermediate key points is aligned with the barycenter of the original key points.

For example, the step S202 may comprise the following steps:

Step S2021: calculating the barycenter of the original key points;

Step S2022: calculating the barycenter of the intermediate key points;

Step S2023: calculating a barycentric vector of the original key points according to the barycenter of the original key points and the barycenter of the intermediate key points; and

Step S2024: aligning the barycenter of the intermediate key points with the barycenter of the original key points according to the barycentric vector of the original key points, so as to obtain the correction key points.

For example, in the step S2021, the barycenter of the original key points represents an average value of the coordinates of all the original key points of the face. In the step S2022, the barycenter of the intermediate key points represents an average value of the coordinates of all the intermediate key points (that is, all the white points on the face in FIG. 2) of the face.

For example, in a specific example, a human face may comprise five original key points, and the coordinates of the five original key points are (x_{d1}, y_{d1}), (x_{d2}, y_{d2}), (x_{d3}, y_{d3}), (x_{d4}, y_{d4}) and (x_{d5}, y_{d5}) respectively, so that the barycenter of the five original key points may be calculated as ((x_{d1}+x_{d2}+x_{d3}+x_{d4}+x_{d5})/5), ((y_{d1}+y_{d2}+y_{d3}+y_{d4}+y_{d5})/5).

For example, by using the barrel distortion formula to perform calculation on the original key points, the intermediate key points of the human face can be obtained, the human face comprises five intermediate key points which are in one-to-one correspondence to the five original key points, and the coordinates of the five intermediate key points are (xᵤ₁, yᵤ₁), (xᵤ₂, yᵤ₂), (yᵤ₃, yᵤ₃), (xᵤ₄, yᵤ₄) and (xᵤ₅, yᵤ₅) respectively, so that the barycenter of the five intermediate key points may be calculated as ((xᵤ₁+xᵤ₂+xᵤ₃+xᵤ₄+xᵤ₅)/5), ((yᵤ₁+yᵤ₂+yᵤ₃+yᵤ₄+yᵤ₅)/⁵).

It should be noted that, in the above specific examples, the average value of the coordinates refers to a geometric average value. However, the present disclosure is not limited thereto, and the average value of the coordinates may also refer to a weighted average value.

For example, in the step S2023, the barycentric vector refers to a difference between the barycenter of the original key points and the barycenter of the intermediate key points, and the barycentric vector may comprise an X component and a Y component.

For example, in a case that the coordinate of the barycenter of the original key points is ((x_{d1}+x_{d2}+x_{d3}+x_{d4}+x_{d5})/5, (y_{d1}+y_{d2}+y_{d3}+y_{d4}+y_{d5})/5), and the coordinate of the barycenter of the intermediate key points is ((xᵤ₁+xᵤ₂+xᵤ₃+xᵤ₄+xᵤ₅)/5, (yᵤ₁+yᵤ₂+yᵤ₃+yᵤ₄+yᵤ₅)/5), so the barycentric vector can be expressed as ((x_{d1}+x_{d2}+x_{d3}+x_{d4}+x_{d5})/5−(xᵤ₁+xᵤ₂+xᵤ₃+xᵤ₄+xᵤ₅)/5, (y_{d1}+y_{d2}+y_{d3}+y_{d4}+y_{d5})/5−(yᵤ₁+yᵤ₂+yᵤ₃₊yᵤ₄₊yᵤ₅)/5). The X component is (x_{d1}+x_{d2}+x_{d3}+x_{d4}+x_{d5})/5−(xᵤ₁+xᵤ₂+xᵤ₃+xᵤ₄+xᵤ₅)/5, and the Y component is (y_{d1}+y_{d2}+y_{d3}+y_{d4+}y_{d5})/5−(yᵤ₁+yᵤ₂+yᵤ₃₊yᵤ₄₊yᵤ₅)/5.

For example, if the barycentric vector is obtained by subtracting the barycenter of the intermediate key points from the barycenter of the original key points, in the step S2024, it is needed to add the barycentric vector to the barycenter of the intermediate key points to align the barycenter of the intermediate key points with the barycenter of the original key points, so as to obtain the correction key points. If the barycentric vector is obtained by subtracting the barycenter of the original key points from the barycenter of the intermediate key points, in the step S2024, it is needed to subtract the barycentric vector from the barycenter of the intermediate key points to align the barycenter of the intermediate key points with the barycenter of the original key points, so as to obtain the correction key points.

It should be noted that, in the barrel distortion formula, the coordinate of each point (such as, the intermediate key points, the original key points, the correction key points, etc.) represents its coordinate in an image coordinate system. The image coordinate system refers to a coordinate system established on the basis of an optical image of an object acquired by a camera.

For example, the step S30 may comprise the following steps:

Step S301: performing mesh processing on the input image to obtain an original mesh image;

Step S302: performing the deformation processing on the original mesh image according to the original key points and the correction key points to obtain a correction mesh image; and

Step S303: performing pixel-value padding processing on the correction mesh image according to the input image to obtain the output image.

For example, in the step S301, the performing mesh processing on the input image includes adding a uniformly-spaced mesh on the input image to obtain the original mesh image, and then the deformation processing is performed on respective intersection points of the original mesh image, so as to reduce an amount of calculation and improve a speed of image processing. The size of the original mesh image is less than or equal to the size of the input image. For example, the size of the original mesh image is equal to the size of the input image, the size of the input image is UxQ, and the original mesh image has MxN mesh intersection points. In the original mesh image, in a row direction, a distance between two adjacent mesh intersection points is U/(M−1); in a column direction, a distance between two adjacent mesh intersection points is Q/(N−1). For example, if U is 1000, Q is 500, M is 11, and N is 6, in the row direction of the original mesh image, the distance between two adjacent mesh intersection points is 1000/(11−1)=100; and in the column direction of the original mesh image, the distance between two adjacent mesh intersection points is 500/(6−1)=100.

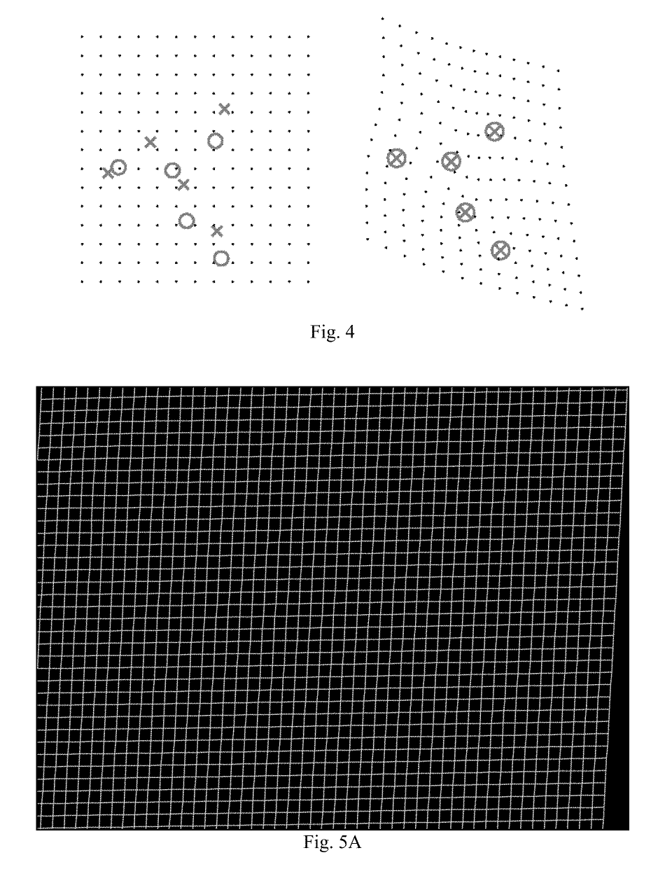

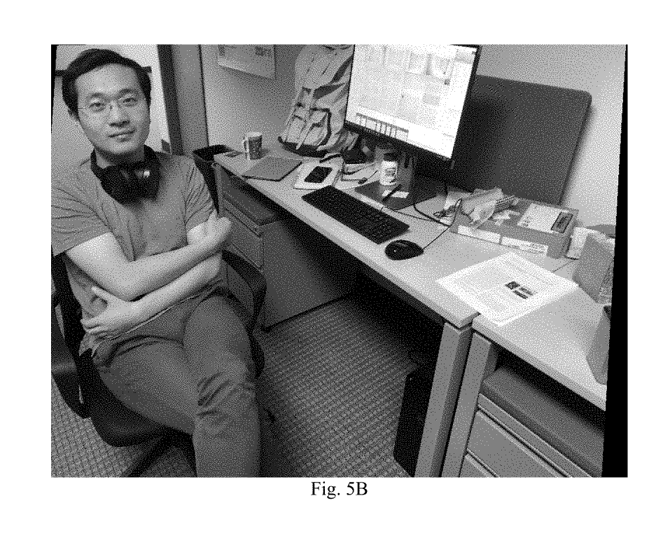

FIG. 4 is a schematic diagram of performing interpolation processing on an original mesh image by using thin plate spline interpolation according to an embodiment of the present disclosure; FIG. 5A is a schematic diagram of a correction mesh image provided by an embodiment of the present disclosure; and FIG. 5B is a schematic diagram of a correction image corresponding to a correction mesh image provided by an embodiment of the present disclosure.

For example, in the step S302, the deformation processing is performed on all intersection points of the original mesh image according to the corresponding relationship between the original key points and the correction key points, so as to obtain the correction mesh image. For example, the step S302 may comprise:

Step S3021: performing first interpolation processing according to the original key points and the correction key points to obtain respective moving vectors of a plurality of intersection points of the original mesh image; and

Step S3022: obtaining the correction mesh image according to respective positions and moving vectors of the plurality of intersection points of the original mesh image.

For example, in the step S3021, the first interpolation processing may comprise thin plate spline interpolation processing. The thin plate spline interpolation processing can smoothly spread a local motion to other areas of the image.

In some embodiments, the step S3021 may comprise: obtaining moving vectors of the original key points according to the original key points and the correction key points; performing the first interpolation processing according to the moving vectors of the original key points, to obtain respective moving vectors of the plurality of intersection points of the original mesh image. For example, parameters of an interpolation formula of the thin plate spline interpolation are calculated and obtained according to the moving vectors of the original key points; the respective moving vectors of the plurality of intersection points of the original mesh image are calculated and obtained according to the parameters and the interpolation formula, where each of the moving vectors comprises a first moving component and a second moving component. The original key points are moved to the positions of the correction key points according to the moving vectors of the original key points.

In a case that the first interpolation processing is the thin plate spline interpolation processing, a moving vector of an intersection point at the coordinate (x, y) is calculated by the following formula:

$$f ( x , y ) = {a}_{1} + {a}_{2} \cdot x + {a}_{3} \cdot y + {\sum }_{i = 1}^{n} {ω}_{i} \cdot U ( \vert {P}_{i} - ( x , y ) \vert ) ,$$

here, a₁, a₂, a₃ and wᵢ are parameters to be determined, U is a radial basis function, U(r)=r²·log r, r=|Pᵢ−(x, y)|, Pᵢ denotes a coordinate of the i-th original key point. f (x,y) is a moving vector of an intersection point at the coordinate (x, y) on the original mesh image, and comprises two moving components f_{X} (x,y) and f_{Y} (x,y).

For example, the parameters of the interpolation formula comprises a first group of interpolation parameters and a second group of interpolation parameters, which are used to calculate the two moving components of each intersection point respectively. For example, if the first moving component is a moving component in an X direction (such as a horizontal direction) and the second moving component is a moving component in a Y direction (such as a vertical direction), the first group of interpolation parameters are parameters of the thin plate spline interpolation formula in the X direction and the second group of interpolation parameters are parameters of the thin plate spline interpolation formula in the Y direction. For example, the first group of interpolation parameters can be calculated according to first moving components of already-known original key points, and the second group of interpolation parameters can be calculated according to the second moving components of the already-known original key points.

For example, the first group of interpolation parameters can be calculated by the following formula:

$$[ \begin{matrix}K & P \\ {P}^{′} & 0\end{matrix} ] [ \begin{matrix}{W}_{1} \\ {a}_{11} \\ {a}_{12} \\ {a}_{13}\end{matrix} ] = {Y}_{1}$$

$$here , K = [ \begin{matrix}U ( {r}_{11} ) & U ( {r}_{12} ) & … \\ U ( {r}_{21} ) & U ( {r}_{22} ) & … \\ … & … & U ( {r}_{nn} )\end{matrix} ] , P = [ \begin{matrix}1 & {x}_{1} & {y}_{1} \\ … & … & … \\ 1 & {x}_{n} & {y}_{n}\end{matrix} ] ,$$

W₁=[ω₁₁ . . . ω₁ₙ]′, Y₁=[ν₁₁ . . . ν₁ₙ 0 0 0]′, n denotes the number of the original key points, U(rᵢⱼ) denotes a distance between the i-th original key point and the j-th original key point, rᵢⱼ=|Pᵢ−Pⱼ|, Pᵢ denotes a coordinate of the i-th original key point, Pⱼ denotes a coordinate of the j-th original key point, and respective elements in Y₁ denote the first moving components of respective original key points (that is, ν₁ₙ denotes the first moving component of the n-th original key point). “′” denotes the transpose of a matrix. For example, the first component Y₁ of original key points may represent X coordinate differences between the original key points and the correction key points corresponding to the original key points.

For example, the second group of interpolation parameters can be calculated by the following formula:

$$[ \begin{matrix}K & P \\ {P}^{′} & 0\end{matrix} ] [ \begin{matrix}{W}_{2} \\ {a}_{21} \\ {a}_{22} \\ {a}_{23}\end{matrix} ] = {Y}_{2}$$

$$here , K = [ \begin{matrix}U ( {r}_{11} ) & U ( {r}_{12} ) & … \\ U ( {r}_{21} ) & U ( {r}_{22} ) & … \\ … & … & U ( {r}_{nn} )\end{matrix} ] , P = [ \begin{matrix}1 & {x}_{1} & {y}_{1} \\ … & … & … \\ 1 & {x}_{n} & {y}_{n}\end{matrix} ] ,$$

W₂=[ω₂₁ . . . ω₂ₙ]′, Y₂=[ν₂₁ . . . ν₂ₙ 0 0 0]′, and respective elements in Y₂ denote the second moving components of respective original key points (that is, ν₂ₙ denotes the second moving component of the n-th original key point). For example, the second component Y₂ of original key points may represent Y coordinate differences between the original key points and the correction key points corresponding to the original key points.

The first group of interpolation parameters and the second group of interpolation parameters of the interpolation formula of the thin plate spline interpolation can be obtained by solving the above linear equations respectively.

For example, in a specific example, if the coordinate of an original key point is (1, 2) and the coordinate of a correction key point corresponding to the original key point is (3, 4), then for the original key point at the coordinate (1, 2), Y₁=3−1=2, and Y₂=4−2=2.

For example, according to the first group of interpolation parameters a₁₁, a₁₂, a₁₃ and w₁ᵢ, the first moving component of the intersection point at the coordinate (x, y) on the original mesh image can be calculated by using the interpolation formula of the thin plate spline interpolation as follows:

$${f}_{X} ( x , y ) = {a}_{11} + {a}_{12} \cdot x + {a}_{13} \cdot y + {\sum }_{i = 1}^{n} {ω}_{1 i} \cdot U ( \vert {P}_{i} - ( x , y ) \vert ) .$$

According to the second group of interpolation parameters a₂₁, a₂₂, a₂₃ and w₂, the second moving component of the intersection point at the coordinate (x, y) on the original mesh image can be calculated by using the interpolation formula of the thin plate spline interpolation as follows:

$${f}_{Y} ( x , y ) = {a}_{21} + {a}_{22} \cdot x + {a}_{23} \cdot y + {\sum }_{i = 1}^{n} {ω}_{2 i} \cdot U ( \vert {P}_{i} - ( x , y ) \vert ) .$$

Here, f_{X} (x,y) denotes the first moving component of the intersection point at the coordinate (x, y), and f_{Y} (x,y) denotes the second moving component of the intersection point at the coordinate (x, y).

For example, in the step S3022, the positions of respective intersection points may be represented by coordinates of the respective intersection points. The step S3022 comprises: moving the coordinates of respective intersection points of the original mesh image according to the moving vectors of respective intersection points of the original mesh image to obtain the correction mesh image.

For example, a view on the left side of FIG. 4 shows a schematic diagram of the original mesh image before the thin plate spine interpolation processing is performed, and a view on the right side of FIG. 4 shows a schematic diagram of the correction mesh image obtained by performing the thin plate spine interpolation processing on the original mesh image. As shown in the left side view of FIG. 4, circles (◯) represent the original key points, and the crosses (×) represent the correction key points. As shown in the right side view of FIG. 4, when the original key points are moved to the positions of the correction key points (that is, the circles coincide with the crosses), the thin plate spine interpolation can be used to calculate the moving vectors of all intersection points of the original mesh image, and furthermore target positions of the intersection points (that is, the coordinates of respective intersection points of the correction mesh image) can be determined, so as to obtain the correction mesh image (as shown in the right side view of FIG. 4).

For example, the first interpolation processing is not limited to the above-described thin plate spline interpolation processing. The first interpolation processing may further comprise other interpolation methods, such as an inverse distance weighting processing method, a radial basis function method, a subdivision surface method, and the like.

For example, as shown in FIG. 5A, after the first interpolation processing is performed on the original mesh image, the correction mesh image may be obtained. FIG. 5B shows a correction image corresponding to a correction mesh image, that is, a pixel value of each pixel in the correction mesh image is determined according to the input image, so as to obtain the correction image. As shown in FIG. 5B, on the correction image, the key points of the human face have been located at predetermined positions respectively through the deformation processing; however, other parts of the correction image (for example, a table at a lower right corner of the image) are also distorted. In order to ensure that the deformation only affects the part of human face, the face area of the correction image and the non-face area of the input image can be fused to obtain the output image with a local face area of the output image being restored, so as to ensure that the non-face area is not affected by the deformation.

For example, the step S303 may comprise the following steps:

Step S3031: performing fusion processing on a non-face area of the original mesh image and a face area of the correction mesh image to obtain an output mesh image; and

Step S3032: determining a pixel value of each pixel in the output mesh image according to the input image to obtain the output image.

For example, the step S3031 comprises: obtaining a face mask of the input image according to the original key points; performing blurring processing on the face mask to obtain a blurred face mask; obtaining a blurred non-face mask according to the blurred face mask; obtaining the non-face area of the original mesh image according to the blurred face mask and the original mesh image; obtaining the face area of the correction mesh image according to the blurred non-face mask and the correction mesh image; and fusing the non-face area of the original mesh image and the face area of the correction mesh image to obtain the output mesh image.

For example, in the face detection process of the step S10, three-dimensional information of the face in the input image may be built based on the original key points, so as to obtain the face area in the input image. Thus, in the step S3031, the face mask can be obtained according to the face area.

For example, the face detection process further comprises: detecting whether the three-dimensional information of the face matches a three-dimensional shape of the real face or not; in a case that the built three-dimensional information of the face is determined to be matched with the three-dimensional shape of the real face, determining that the face detection is successful, and then obtaining the face area of the input image according to the three-dimensional information of the face; and in a case that the built three-dimensional information of the face is determined to be not matched with the three-dimensional shape of the real face, rebuilding the three-dimensional information of the face or determining that the face detection fails(for example, there is no face in the input image).

For example, a determination that the three-dimensional information of the face matches the three-dimensional shape of the real face may indicate that the original key points of the built face correspond to the original key points of the real face, that is, the built face has the original key points (eyes, nose, mouth, etc.) included in the real face; on the other hand, the determination that the three-dimensional information of the face matches the three-dimensional shape of the real face may also indicate that a relative position relationship among the original key points of the built face matches a relative position relationship among the original key points of the corresponding real face. For example, the relative position relationship may comprise a relative position between the nose and the mouth, a distance between two eyes of a person, and the like.

For example, blurring processing can make transition between the face area and the non-face area to be more natural. The blurring processing comprises Gaussian blur.

For example, the face mask may be represented as a matrix where each pixel value in the face area is 0 and each pixel value in the non-face area is 1. The size of the face mask may be the same as the size of the input image.

For example, the output mesh image may be expressed as:

W_{O}=W_{I}*Mₐ+W_{co}*M_{b}=W₁*Mₐ+W_{co}*(M₁−Mₐ).

Here, W_{O} denotes the output mesh image, W_{I} denotes the original mesh image, Wi_{co} denotes the correction mesh image, Mₐ denotes the blurred face mask, M_{b} denotes the blurred non-face mask, M_{b}=M₁−Mₐ, M₁ denotes an all 1 matrix, and “*” denotes the

Hadamard product of the matrix, and the Hadamard product represents a product of corresponding elements at a same position between two matrices.

For example, the step S3032 may comprise: performing mesh triangulation processing on the output mesh image to obtain an intermediate mesh image; performing second interpolation processing according to the input image to determine a pixel value of each pixel in the intermediate mesh image, so as to obtain an intermediate output image; and performing cropping processing on the intermediate output image to obtain the output image.

For example, the mesh triangulation processing includes that a quadrilateral formed by four intersection points in the output mesh image is divided into two triangles along a diagonal, that is, the output mesh image is converted into a triangular mesh image, so as to obtain the intermediate mesh image.

For example, the second interpolation processing may comprise resampling. The resampling may comprise bilinear interpolation. But the present disclosure is not limited thereto, and the second interpolation processing may further comprise other interpolation methods, such as nearest neighbor interpolation, bicubic interpolation, or cubic convolution interpolation, etc.

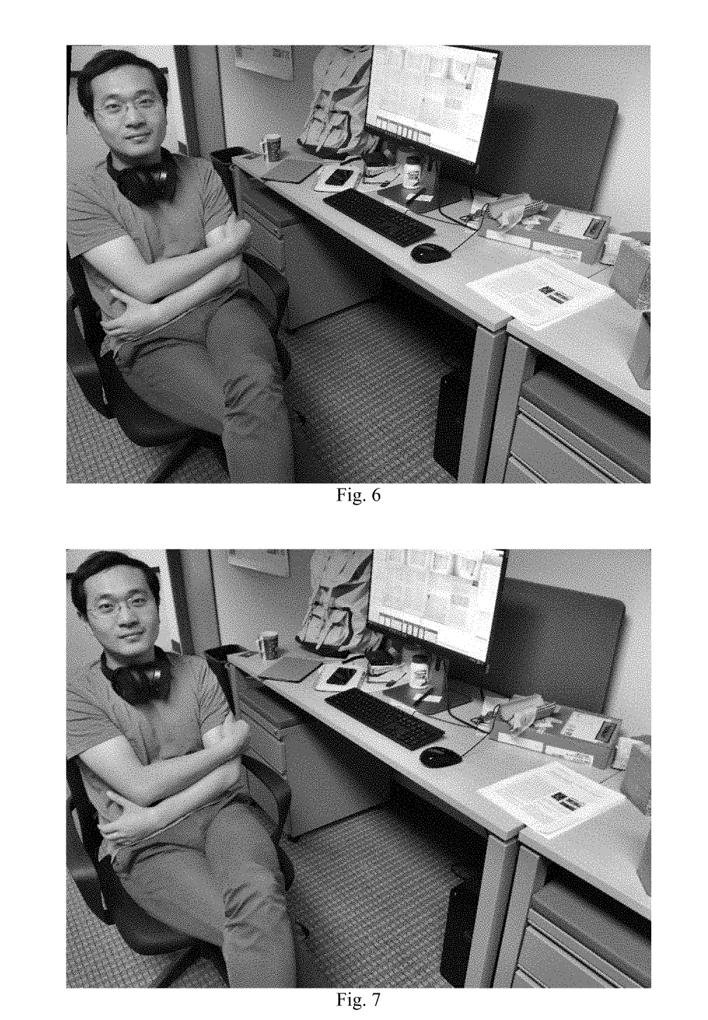

FIG. 6 is a schematic diagram of an intermediate output image provided by an embodiment of the present disclosure; and FIG. 7 is a schematic diagram of an output image provided by an embodiment of the present disclosure.

For example, as shown in FIG. 6, an image edge of the intermediate output image obtained according to the intermediate mesh image may have a black edge. In order to remove the black edge, the intermediate output image may be cropped to obtain the output image. As shown in FIG. 7, the black edge at the edge of the output image has been removed.

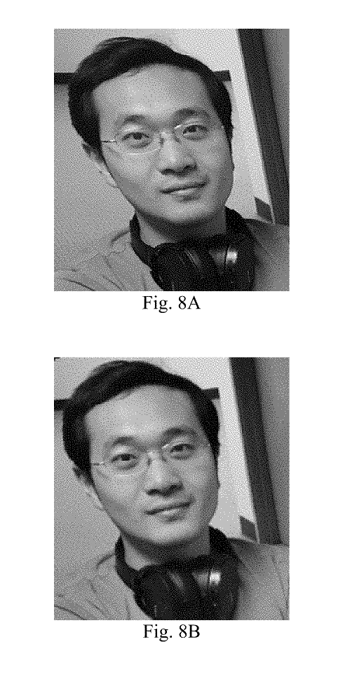

FIG. 8A is a schematic diagram of a face area before distortion correction according to an embodiment of the present disclosure; and FIG. 8B is a schematic diagram of a face area obtained by processing the face area shown in FIG. 8A using an image processing method provided by an embodiment of the present disclosure. For example, as shown in FIG. 8A and FIG. 8B, before performing the distortion correction on the face area, the face is distorted. After performing the distortion correction on the face area, the face area is restored.

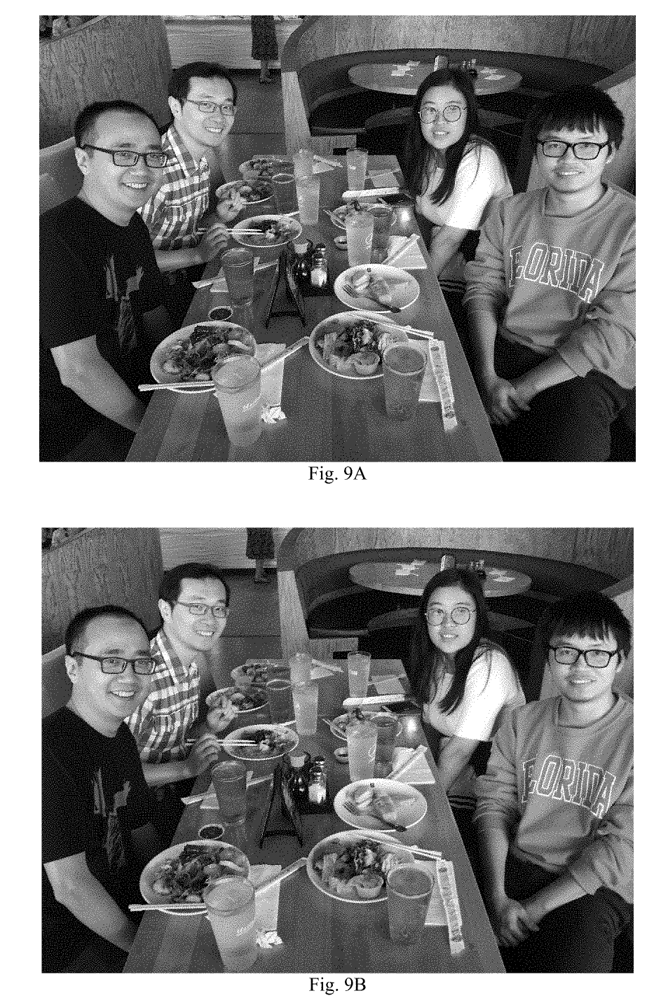

FIG. 9A is a schematic diagram of an input image before distortion correction according to an embodiment of the present disclosure; and FIG. 9B is a schematic diagram of an output image obtained by processing the input image shown in FIG. 9A using an image processing method provided by an embodiment of the present disclosure.

For example, as shown in FIG. 9A, the input image may comprise a plurality of faces. When the input image comprises a plurality of faces, the image processing method may comprise the following steps:

Step S11: performing the face detection on the input image to obtain respective original key points of each face of the plurality of faces;

Step S21: converting the respective original key points of each face into intermediate key points of each face by using a barrel distortion formula; and aligning a barycenter of the intermediate key points of each face with a barycenter of the original key points of each face to obtain the correction key points of each face; and

Step S31: performing mesh processing on the input image to obtain an original mesh image; performing the deformation processing on the original mesh image according to the original key points and the correction key points of the plurality of faces to obtain a correction mesh image; and performing pixel-value padding processing on the correction mesh image according to the input image to obtain the output image.

For example, as shown in FIG. 9B, after performing correcting processing on the input image by the image processing method according to an embodiment of the present disclosure, all the faces on the output image are corrected, and the shapes of the faces are restored.

For example, when the input image comprises the plurality of faces, in the step S11, for the method of the face detection, reference may be made to the description of the above-mentioned step S10, and in the step S21, for the specific process of aligning the barycenters, reference may be made to the description of the above-mentioned step S20. Similar description will be omitted here.

For example, when the input image comprises the plurality of faces, in the step S31, the parameters of the interpolation formula of the thin plate spline interpolation are calculated according to the original key points and the correction key points of the plurality of faces; and then the moving vectors of respective intersection points of the original mesh image are determined according to the calculated parameters.

For example, when the input image comprises the plurality of faces, a specific operation of the step S31 may be referred to the above-mentioned step S301, step S302 and step S303. The difference includes that, in the step S303, the face mask of the input image comprises a plurality of face areas.

For example, when the input image comprises a plurality of faces, according to actual application needs, the correcting processing may be performed on some faces of the plurality of faces. For example, the correcting processing may be performed on the face(s) located at the edge of the image; alternatively, the correcting processing may also be performed on all the faces on the input image.

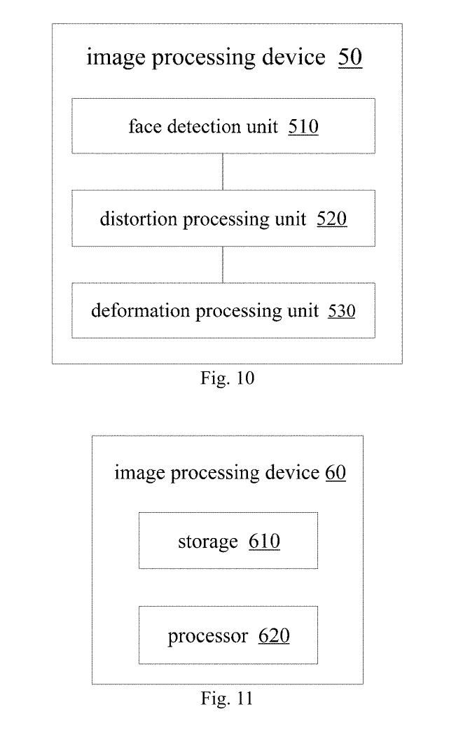

FIG. 10 is a schematic block diagram of an image processing device provided by an embodiment of the present disclosure.

For example, as shown in FIG. 10, an image processing device 50 provided by an embodiment of the present disclosure may comprise a face detection unit 510, a distortion processing unit 520 and a deformation processing unit 530. The face detection unit 510 is configured to perform face detection on an input image to obtain original key points; the distortion processing unit 520 is configured to perform distortion processing on the input image to obtain correction key points corresponding to the original key points of the input image; and the deformation processing unit 530 is configured to perform deformation processing on the input image according to the correction key points and the original key points to obtain an output image.

The image processing device provided by an embodiment of the present disclosure can restore a face shape of a person or face shapes of multiple persons by superimposing a barrel distortion on the input image, restore the shape of the face at the edge of the input image by using the local mesh thin plate spline interpolation, and ensure that the non-face area is not affected by the deformation.

For example, the image processing device 50 may be applied in any electronic device having a photographing function or a filming function. The electronic device, for example, may comprise a smart phone, a tablet, a digital camera, or the like. It should be understood that, the image processing device 50 may also be an independent electronic device.

For example, the face detection unit 510, the distortion processing unit 520 and the deformation processing unit 530 may be hardware, software, firmware or any suitable combination thereof

For example, the input image may be acquired by an image acquisition device, and transmitted to the image processing device 50. The image acquisition device may comprise a camera in a smart phone, a camera in a tablet computer, a camera in a personal computer, a digital camera, or a network camera, etc.

It should be noted that, for the specific function of the face detection unit 510, reference may be made to an operation process of the step S10 or step S11 of the image processing method in the above-mentioned embodiments. For the specific function of the distortion processing unit 520, reference may be made to an operation process of the step S20 or step S21 of the image processing method in the above-mentioned embodiments. For the specific function of the deformation processing unit 530, reference may be made to an operation process of the step S30 or step S31 of the image processing method in the above-mentioned embodiments. Similar description will be omitted here.

FIG. 11 is a schematic block diagram of another image processing device provided by an embodiment of the present disclosure.

For example, as shown in FIG. 11, an image processing device 60 provided by another embodiment of the present disclosure may comprise a storage 610 and a processor 620. The storage 610 and the processor 620 may be connected with each other by a bus system and/or other forms of connection mechanism (not show in FIG. 11). It should be noted that the components and structures of the image processing device shown in FIG. 11 are merely exemplary and not limitative, and the image processing device may also comprise other components and structures as needed.

The image processing device provided by embodiments of the present disclosure can restore a face shape of a person or face shapes of multiple persons by superimposing a barrel distortion on the input image, restore the shape of the face at the edge of the input image by using the local mesh thin plate spline interpolation, and ensure that the non-face area is not affected by the deformation.

For example, the storage 610 is used to store non-transitory computer-readable instructions.

For example, the processor 620 is used to execute the non-transitory computer-readable instructions. The non-transitory computer-readable instructions, as executed by the processor 620, may perform one or more steps in the above-described image processing method. Specifically, the non-transitory computer-readable instructions, as executed by the processor 620, may perform steps of: performing face detection on an input image to obtain original key points; performing distortion processing on the input image to obtain correction key points corresponding to the original key points of the input image; and performing deformation processing on the input image according to the correction key points and the original key points to obtain an output image.

For example, in an example, the step of performing distortion processing on the input image to obtain correction key points corresponding to the original key points of the input image comprises: converting the original key points of the input image into intermediate key points by using a barrel distortion formula; and aligning a barycenter of the intermediate key points with a barycenter of the original key points to obtain the correction key points.

For example, in an example, the step of performing deformation processing on the input image according to the correction key points and the original key points to obtain an output image comprises: performing mesh processing on the input image to obtain an original mesh image; performing the deformation processing on the original mesh image according to the original key points and the correction key points to obtain a correction mesh image; and performing pixel-value padding processing on the correction mesh image according to the input image to obtain the output image.

For example, the image processing device 60 may be applied in any electronic device having a photographing function or a filming function. The electronic device, for example, may comprise a smart phone, a tablet, a digital camera, or the like.

It should be noted that the storage 610, the processor 620, and the like may be disposed at a server side (or a cloud side). Obviously, the embodiments of the present disclosure are not limited thereto, and the storage 610, the processor 620, and the like may also be disposed at an image acquiring side.

For example, the processor 620 may be a central processing unit (CPU) or another form of processing units having data processing capabilities and/or program execution capabilities, such as a graphics processing unit (GPU), a field-programmable gate array (FPGA), or a tensor processing unit (TPU). For example, the central processing unit (CPU) may be X86, ARM architecture, or the like. The processor 620 may control other components in the image processing device 60 to perform a desired function.

For example, the storage 610 may comprise an arbitrary combination of one or more computer program products. The computer program products may comprise various forms of computer-readable storage media, such as volatile memory and/or non-volatile memory. The volatile memory may comprise, for example, a random access memory (RAM) and/or a cache or the like. The non-volatile memory may comprise, for example, a read only memory (ROM), a hard disk, an erasable programmable read only memory (EPROM), a compact disc-read only memory (CD-ROM), a USB memory, a flash memory, and the like. One or more computer programs may be stored on the computer-readable storage medium and the processor 620 may execute the non-transitory computer-readable instructions to implement various functions of the image processing device 60. Various applications, various data, various data used and/or generated by the applications, and the like, may also be stored in the computer-readable storage medium.

It should be noted that, for detailed description of the image processing performed by the image processing device 60, reference may be made to the related description in the embodiments of the image processing method, and details are not repeated herein.

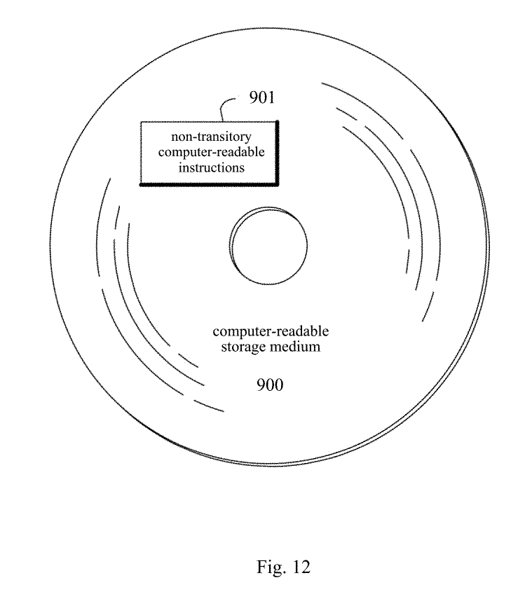

FIG. 12 is a schematic diagram of a computer-readable storage medium provided by an embodiment of the present disclosure. For example, the computer-readable storage medium is used for storing non-transitory computer-readable instructions. As shown in FIG. 12, one or more non-transitory computer-readable instructions 901 may be stored in the computer-readable storage medium 900. For example, the non-transitory computer-readable instructions 901, as executed by a computer, may perform one or more steps in the above-described image processing method. Specifically, the non-transitory computer-readable instructions 901, as executed by a computer, may perform steps of: performing face detection on an input image to obtain original key points; performing distortion processing on the input image to obtain correction key points corresponding to the original key points of the input image; and performing deformation processing on the input image according to the correction key points and the original key points to obtain an output image.

For example, in an example, the step of performing distortion processing on the input image to obtain correction key points corresponding to the original key points of the input image comprises: converting the original key points of the input image into intermediate key points by using a barrel distortion formula; and aligning a barycenter of the intermediate key points with a barycenter of the original key points to obtain the correction key points.

For example, the step of performing deformation processing on the input image according to the correction key points and the original key points to obtain an output image comprises: performing mesh processing on the input image to obtain an original mesh image; performing the deformation processing on the original mesh image according to the original key points and the correction key points to obtain a correction mesh image; and performing pixel-value padding processing on the correction mesh image according to the input image to obtain the output image.

For example, the computer-readable storage medium 900 may be applied in the above-described image processing device. For example, the computer-readable storage medium 900 may be the storage 610 of the image processing device 60 in the embodiment shown in FIG. 11.

For example, the description of the computer-readable storage medium 900 may be referred to the description of the storage 610 in the embodiment of the image processing device 60 shown in FIG. 11. Similar description will be omitted here.

For the present disclosure, the following statements should be noted:

(1) the accompanying drawings involve only the structure(s) in connection with the embodiment(s) of the present disclosure, and other structure(s) can be referred to in common design(s); and

(2) in case of no conflict, the embodiments of the present disclosure and the features in the embodiment(s) can be combined with each other to obtain new embodiment(s).

What have been described above are only specific implementations of the present disclosure, the protection scope of the present disclosure is not limited thereto, and the protection scope of the present disclosure should be based on the protection scope of the claims.

What is claimed is:

1. An image processing method, comprising:
performing face detection on an input image to obtain original key points;
performing distortion processing on the input image to obtain correction key points corresponding to the original key points of the input image; and
performing deformation processing on the input image according to the correction key points and the original key points to obtain an output image.

2. The image processing method according to claim 1, wherein the performing distortion processing on the input image to obtain correction key points corresponding to the original key points of the input image comprises:
converting the original key points of the input image into intermediate key points by using a barrel distortion formula; and
aligning a barycenter of the intermediate key points with a barycenter of the original key points to obtain the correction key points.

3. The image processing method according to claim 2, wherein the aligning the barycenter of the intermediate key points with the barycenter of the original key points to obtain the correction key points comprises:
calculating the barycenter of the original key points;
calculating the barycenter of the intermediate key points;
calculating a barycentric vector of the original key points according to the barycenter of the original key points and the barycenter of the intermediate key points; and
aligning the barycenter of the intermediate key points with the barycenter of the original key points according to the barycentric vector of the original key points, so as to obtain the correction key points.

4. The image processing method according to claim 1, wherein the performing deformation processing on the input image according to the correction key points and the original key points to obtain the output image comprises:
performing mesh processing on the input image to obtain an original mesh image;
performing the deformation processing on the original mesh image according to the original key points and the correction key points to obtain a correction mesh image; and
performing pixel-value padding processing on the correction mesh image according to the input image to obtain the output image.

5. The image processing method according to claim 4, wherein the performing the deformation processing on the original mesh image according to the original key points and the correction key points to obtain the correction mesh image comprises:
performing first interpolation processing according to the original key points and the correction key points to obtain respective moving vectors of a plurality of intersection points of the original mesh image; and
obtaining the correction mesh image according to respective positions and the respective moving vectors of the plurality of intersection points of the original mesh image.

6. The image processing method according to claim 5, wherein the first interpolation processing comprises thin plate spline interpolation processing, and
the performing first interpolation processing according to the original key points and the correction key points to obtain respective moving vectors of the plurality of intersection points of the original mesh image comprises:
obtaining moving vectors of the original key points according to the original key points and the correction key points;
calculating parameters of a interpolation formula of the thin plate spline interpolation according to the moving vectors of the original key points; and
calculating the respective moving vectors of the plurality of intersection points of the original mesh image according to the parameters and the interpolation formula, each of the moving vectors comprising a first moving component and a second moving component.

7. The image processing method according to claim 4, wherein the performing pixel-value padding processing on the correction mesh image according to the input image to obtain the output image comprises:
performing fusion processing on a non-face area of the original mesh image and a face area of the correction mesh image to obtain an output mesh image; and
determining a pixel value of each pixel in the output mesh image according to the input image, so as to obtain the output image.

8. The image processing method according to claim 7, wherein the performing fusion processing on the non-face area of the original mesh image and the face area of the correction mesh image comprises:
obtaining a face mask of the input image according to the original key points;
performing blurring processing on the face mask to obtain a blurred face mask;
obtaining a blurred non-face mask according to the blurred face mask;
obtaining the non-face area of the original mesh image according to the blurred face mask and the original mesh image;
obtaining the face area of the correction mesh image according to the blurred non-face mask and the correction mesh image; and
fusing the non-face area of the original mesh image and the face area of the correction mesh image to obtain the output mesh image.

9. The image processing method according to claim 8, wherein the output mesh image is expressed as:
W_{O}=W_{I}·Mₐ+W_{co}·M_{b},
wherein W_{O} denotes the output mesh image, W_{I} denotes the original mesh image, W_{co} denotes the correction mesh image, Mₐ denotes the blurred face mask, and M_{b} denotes the blurred non-face mask, M_{b}=M₁−Mₐ, M₁ denotes an all 1 matrix.

10. The image processing method according to claim 8, wherein the blurring processing comprises Gaussian blur.

11. The image processing method according to claim 7, wherein the determining the pixel value of each pixel in the output mesh image according to the input image to obtain the output image comprises:
performing mesh triangulation processing on the output mesh image to obtain an intermediate mesh image;
performing second interpolation processing according to the input image to determine a pixel value of each pixel in the intermediate mesh image, so as to obtain an intermediate output image; and
performing cropping processing on the intermediate output image to obtain the output image.

12. The image processing method according to claim 11, wherein the second interpolation processing comprises bilinear interpolation.

13. The image processing method according to claim 1, wherein the input image comprises a plurality of faces, and the performing face detection on the input image to obtain original key points comprises:
performing the face detection on the input image to obtain original key points of each face of the plurality of faces.

14. The image processing method according to claim 13, wherein the performing distortion processing on the input image to obtain correction key points corresponding to the original key points of the input image comprises:
converting the original key points of each face into intermediate key points of each face by using a barrel distortion formula; and
aligning a barycenter of the intermediate key points of each face with a barycenter of the original key points of each face to obtain the correction key points of each face.

15. The image processing method according to claim 14, wherein the performing deformation processing on the input image according to the correction key points and the original key points to obtain the output image comprises:
performing mesh processing on the input image to obtain an original mesh image;
performing the deformation processing on the original mesh image according to original key points and correction key points of the plurality of faces to obtain a correction mesh image; and
performing pixel-value padding processing on the correction mesh image according to the input image to obtain the output image.

16. An image processing device, comprising:
a storage, used for storing non-transitory computer-readable instructions; and
a processor, used for executing the non-transitory computer-readable instructions,
wherein the non-transitory computer-readable instructions, as executed by the processor, cause the processor to perform steps including:
performing face detection on an input image to obtain original key points;
performing distortion processing on the input image to obtain correction key points corresponding to the original key points of the input image; and
performing deformation processing on the input image according to the correction key points and the original key points to obtain an output image.

17. The image processing device according to claim 16, wherein the step of performing distortion processing on the input image to obtain correction key points corresponding to the original key points of the input image comprises:
converting the original key points of the input image into intermediate key points by using a barrel distortion formula; and
aligning a barycenter of the intermediate key points with a barycenter of the original key points to obtain the correction key points.

18. The image processing device according to claim 16, wherein the step of performing deformation processing on the input image according to the correction key points and the original key points to obtain the output image comprises:
performing mesh processing on the input image to obtain an original mesh image;
performing the deformation processing on the original mesh image according to the original key points and the correction key points to obtain a correction mesh image; and
performing pixel-value padding processing on the correction mesh image according to the input image to obtain the output image.

19. A computer-readable storage medium, used for storing non-transitory computer-readable instructions, the non-transitory computer-readable instructions as executed by a computer cause the computer to perform steps including:
performing face detection on an input image to obtain original key points;
performing distortion processing on the input image to obtain correction key points corresponding to the original key points of the input image; and
performing deformation processing on the input image according to the correction key points and the original key points to obtain an output image.

20. The computer-readable storage medium according to claim 19, wherein the step of performing distortion processing on the input image to obtain correction key points corresponding to the original key points of the input image comprises:
converting the original key points of the input image into intermediate key points by using a barrel distortion formula; and
aligning a barycenter of the intermediate key points with a barycenter of the original key points to obtain the correction key points.

21. The computer-readable storage medium according to claim 19, wherein the step of performing deformation processing on the input image according to the correction key points and the original key points to obtain the output image comprises:
performing mesh processing on the input image to obtain an original mesh image;
performing the deformation processing on the original mesh image according to the original key points and the correction key points to obtain a correction mesh image; and
performing pixel-value padding processing on the correction mesh image according to the input image to obtain the output image.
